(19) United States
(12) Patent Application Publication
(10) Pub. No.: US 2006/0073367 A1
(43) Pub. Date: Apr. 6, 2006

(54) Fuel cell system

(75) Inventors: Yoshihito Kanno, Numazu-shi (JP); Shuji Hirakata, Susono-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/244,059

(22) Filed: Oct. 6, 2005

Related U.S. Application Data
(63) Continuation of application No. PCT/JP04/05165, filed on Apr. 9, 2004.

(30) Foreign Application Priority Data
Apr. 9, 2003 (JP) 2003-104957

(51) Int. Cl. H01M 8/04

(52) U.S. Cl. 429/24; 429/22; 429/13

(57) ABSTRACT

A fuel cell system of the present invention performs power generation stoppage control for stopping a power generating operation after generating power for making a temperature of a specified portion of a fuel cell be a specified value or greater when the power generating operation of the fuel cell is stopped.

This is a Continuation of Application No. PCT/JP2004/005165 filed Apr. 9, 2004. The entire disclosure of the prior application is hereby incorporated by reference herein in its entirety.

### BACKGROUND OF THE INVENTION

1. Field of the Invention

The present invention relates to a fuel cell system. More particularly, the invention relates to a fuel cell system installable in a vehicle such as an electric vehicle.

2. Description of the Related Art

Attention in recent years has been focused on fuel cells, which generate electricity by an electrochemical reaction of hydrogen and oxygen as an energy supply source. When a fuel cell or the like using a polyelectrolyte is maintained in a low temperature region of 0° C. or lower, moisture present in the polyelectrolyte and near an electrode thereof freezes while a system using such a cell is stopped inhibiting gas diffusion of fuel gasses (hydrogen gas and air) being supplied, and thereby ionic conductivity in the polyelectrolyte is reduced. Therefore after the fuel cell is stopped, the fuel cell can not be reactivated in the low temperature region after the fuel cell is stopped, and the power generation efficiency is remarkably impaired even if fuel cell can be started.

In accordance with the above situation, conventionally, a fluid such as water is heated by a combustion heater or the like, and then the heated fluid (warm water) is supplied to the fuel cell, thereby warming the fuel cell. In a case of such the process, since the thermal capacity of the fuel cell is large, increasing the temperature requires a long time, and it is difficult to start the fuel cell within a short period of time.

To secure a steady startability (low temperature startability) in the low temperature region of 0° C. or lower, setting the inside of the fuel cell to a dry state before starting is understood to be effective. Techniques regarding methods for improving the low temperature startability by preventing the freezing of the inside of the fuel cell have already been proposed (for instance, see Japanese Patent Application Laid-Open (JP-A) No. 2002-208421). That is, the fuel cell is stopped after the fuel cell is dried by respectively introducing drying hydrogen and drying air, which are not humidified, respectively to an anode side and a cathode side when the operation of the fuel cell is stopped so that the inside of the fuel cell does not freeze while the operation of the fuel cell is stopped. However, though the moisture in a pipe and a gas flow passage can be discharged by introducing the drying hydrogen and the drying air, it is still difficult to remove the moisture present in a polymer electrolyte membrane or an electrode assembly or the like which uses the polymer electrolyte membrane. Therefore, although it is possible to prevent the damage due to freeze or the like, the low temperature startability has not been improved. Further, even if the drying air or the like is heated and introduced, since the thermal capacity of the fuel cell itself is large, by simply introducing the heated air or the like the heat can not contribute to drying. Thus, neither sufficient drying of the polymer electrolyte membrane or the like nor assured low temperature startability is achieved. Further, in order to sufficient dry the polymer electrolyte membrane a lot of time is required.

Documents have already disclosed techniques other than the above technique (for instance, see JP-A Nos. 11-273704 and 2001-102074).

Particularly in fuel cells and the like, which are provided with the electrode assembly using the polymer electrolyte membrane internally, in order to run the fuel cells well it is necessary to provide sufficient fuel gas to a catalyst of an electrode portion. However, under the above present conditions, incases in which moisture remaining in the cell cannot be sufficiently removed, the fuel cell is unable to generate electricity because the fuel gas cannot reach the catalyst at a time of starting due to freezing from a time of stopping. When the fuel cell is installed in an electric vehicle or the like and is used as a main power supply source, since it is necessary for the fuel cell to have performance corresponding to all assumed operating environments, it is desirable to stabilize further operability and re-startability in the low temperature region which is below the freezing point.

### SUMMARY OF THE INVENTION

The present invention has been accomplished in view of the foregoing. An object of the invention is to provide a fuel cell system solving the internal freezing of moisture under low temperature environments, and excelling in low temperature startability.

In order to achieve the above object, a fuel cell system according to the invention comprises a fuel cell, and means for performing power generation stoppage control for stopping power generation after generating power to make the temperature of a specified portion of a fuel cell be a specified value or higher when power generating operation of the fuel cell is stopped.

When the usual power generating operation of the fuel cell is stopped, the fuel cell system of the invention generates power such that the temperature of the specified portion of the fuel cell is a specified value or higher (for instance, in a high load state). The fuel cell system then stops the usual power generating operation. That is, when the temperature of the inside of the fuel cell does not reach the temperature for drying, the fuel cell itself is made to generate the heat to a specified value or higher by further generating power. Then the moisture present in the cell is removed effectively as water vapor by using the heat. As a result, there is no heat consumption by the endotherm of the cell itself, the remaining moisture inside of the cell is changed to water vapor excellent in heat efficiency, and the water vapor can be easily moved. The moisture present not only in a pipe and a flow passage but also inside of the fuel cell including the polymer electrolyte membrane can be dried enough and prompt to the amount of the moisture which does not freeze if cooled below the freezing point.

For instance, in the fuel cell (for instance, a polymer electrolyte fuel cell or the like) which generates electricity by supplying hydrogen gas as fuel gas to a hydrogen pole (anode) side and air (oxygen) to an oxygen pole (cathode) side, exhaust gas (anode off gas and cathode off gas) is respectively exhausted from the anode side and the cathode side. The moisture, which becomes water vapor by the heat at the time of generating electricity adds in the off gas to be removed outside.

In the power generation process in the power generation stoppage control, the power generating operation may be performed such that the specified portion of the fuel cell which is lower than a specified value is heated to a specified value or higher. The level of a process demanded is influenced by the amount of load and the operation time or the like. For instance, power generation (for instance, power supply to an electrothermal heater and vehicle motor driving in a high torque state) in a high load state which demands a lot of power supplies, and power generation in a state of stopping a cooling circulatory system which cools the fuel cell or the like are performed. The temperature of the fuel cell can be increased for a short time by the power generation process.

The temperature of the specified portion of the fuel cell should detect the temperature of the portion in which drying effect can be obtained by the temperature rise. For instance, the temperature near the polymer electrolyte membrane such as the polymer electrolyte membrane composing each stack structural unit and the separator, or the water temperature near an outlet in which circulation water (cooling water) supplied to each stack structural unit is exhausted can be used. The temperature of the specified portion may be set to 60 to 80° C. or higher from the viewpoint of dry efficiency.

A time of stopping power generating operation means for instance, the time of stopping the supply of the hydrogen gas and air (oxygen) and stopping power generation when electrochemical reaction (hereinafter, referred to as cell reaction) for serving power generation is stopped. More specifically, it is the time of usual stopping power generation, the time of temporary stopping power generation (for instance, in a state of the output standby which can be output anytime such that at the time of vehicle's waiting at stoplights), or the time of compulsion stopping at the time of trouble.

Th fuel cell may have a stack portion including a plurality of stack structural units. The power generation stoppage control can be performed in at least one portion of the divided plurality of stack structures. Since the power generating operation control is performed in one portion of the stack portion, only a portion of the amount of moisture present in the cell need to be removed, and thus a sufficiently dry state can be obtained more promptly.

The power generating operation can preferably be started by using the stack structural unit in which the power generation stoppage control is performed at the time of reactivating when the power generation stoppage control is performed in the stack structural unit of a portion of the stack portion. That is, since the power generation stoppage control is performed only in one portion of the stack portion, other stack structural units in which the power generation stoppage control is not performed except the portion may freeze while stopping. However, the stack structural unit of a portion of the stack portion in which the power generation stoppage control is performed when starting is not in a freezing state. Therefore, the entire system can be set to ready for operation while defrosting the frozen stack portion by using the heat produced by operating the portion of the stack structural unit.

When the outside temperature (for instance, temperature outside the vehicle) is a specified value or lower, the above power generation stoppage control can be performed. For instance, when it is recognized that the outside temperature is a specified value or lower when stopping, the power generation stoppage control may be automatically performed. The power generation stoppage control may also be performed by turning on a transfer switch provided on the vehicle manually when the outside temperature is a specified value or lower after stopping the power generating operation of the fuel cell.

The fuel cell system in the invention may include a means for determining whether the inside of the stack portion composing the fuel cell is in a dry state or not, wherein the power generating operation is stopped when the determining means determines that the inside of the stack portion is not in dry state. When especially, the usual power generating operation of the fuel cell is in a low load state, that is, when a usual power generating operation of the fuel cell is stopped from the state that the temperature of the specified portion of the fuel cell does not reach a specified value or higher, for instance, when the power generating operation is stopped from the state of power generation having a lower heating value by cell reaction and the power generating operation is stopped soon after starting, the moisture remaining in the cell can be recognized by the provided dry determining means for determining whether the inside of the stack portion composing the fuel cell is in a dry state or not. When determining that the inside of the fuel cell is not in a dry state, the power generation stoppage control can be selectively performed. As a result, unnecessary power generation need not to be performed, and the fuel consumption for power generation can be reduced and time until stopping can be shortened.

Methods for determining whether it is in a dry state or not include the following methods: a method for determining as a dry state when the resistance value is a specified value or greater by detecting the resistance value of a polymer electrolyte membrane in the stack; a method for estimating the amount of moisture (water budget) which remains in a polymer electrolyte membrane, comparing with the amount of moisture an initial value where the estimation of the amount of the moisture is obtained by estimating the operation time based on the operation state (for instance, the temperature of the stack portion, the humidifying amount to hydrogen gas and air, the current value (the volume of generation water), and the amount of water vapor taken by off gas or the like) from a specified initial value at the time of starting the power generating operation; a method for determining a dry state by the end of the processing time where the processing time is decided from the temperature of the specified portion of the fuel cell when stopping the operation to the electric power load and the power generation time when power generation is operated (the temperature of the specified portion of the fuel cell is a specified value or higher).

The fuel cell in the invention can be composed by a polymer electrolyte fuel cell. For instance, the fuel cell comprises a single cell provided with an electrode assembly having an anode diffusion electrode, a cathode diffusion electrode and a polymer electrolyte membrane held the anode diffusion electrode and the cathode diffusion electrode, and a pair of separators which holds the electrode assembly, and forms a fuel flow passage in which fuel pass through between the anode diffusion electrode and the separator, and an oxidation gas flow passage in which oxidation gas pass between the cathode diffusion electrode and the separator. Desirably, a plurality of single cells are laminated to make stack structure. The anode diffusion electrode and the cathode diffusion electrode can be composed of a catalyst layer for serving electrochemical reaction and a diffusion layer functions as a collector.

### BRIEF DESCRIPTION OF THE DRAWINGS

FIG. 1 is a schematic structural view showing an embodiment of the present invention.

FIG. 2 is a schematic view showing a structure of a fuel cell and a circulation system shown in FIG. 1.

FIG. 3 is a flow chart showing a power generation stoppage control routine for performing power generation stoppage control when power generating operation of a fuel cell system is stopped.

FIG. 4 is a flow chart showing a power generation starting control routine executed when starting the fuel cell system.

FIG. 5 shows one example of a circulation route (circulation route (a)) when starting a first stack or when warming up the first stack at the time of stopping.

FIG. 6 shows one example of a circulation route (circulation route (b)) when starting a second stack.

FIG. 7 shows one example of a circulation route (circulation route (c)) when controlling the fuel cell by a usual power generating operation.

### DESCRIPTION OF THE PREFERRED EMBODIMENT

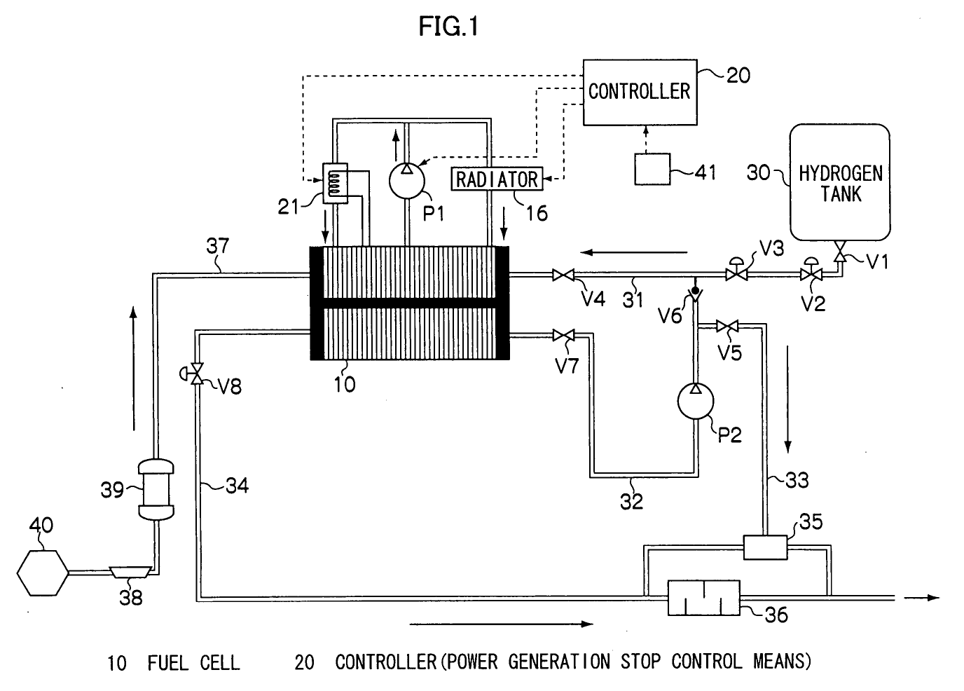

An embodiment of a fuel cell system in the present invention will be described with reference to FIG. 1. In the embodiment, a fuel cell system in a first embodiment of the invention is installed in an electric vehicle movable by a motor that drives wheels by receiving a supply of electric energy. The power generation is stopped at the time of determining that an internal portion of the fuel cell is not in a dry state when the fuel cell system is stopped.

In the present embodiment, a stack portion provided on the fuel cell is composed of two stack units. The power generation is stopped at one of the stacks when power-generating operation is stopped, and the power generating operation is performed by firstly starting the stack unit in which the power generation is stopped when starting.

As shown in FIG. 1, the fuel cell system in the embodiment is provided with a fuel cell 10 and a controller 20. The fuel cell 10 is constituted by laminating a plurality of single cells to make a stack structure, and supplies power to an outside portion. The control unit 20 stops the power generation when the power generation of the fuel cell 10 is stopped.

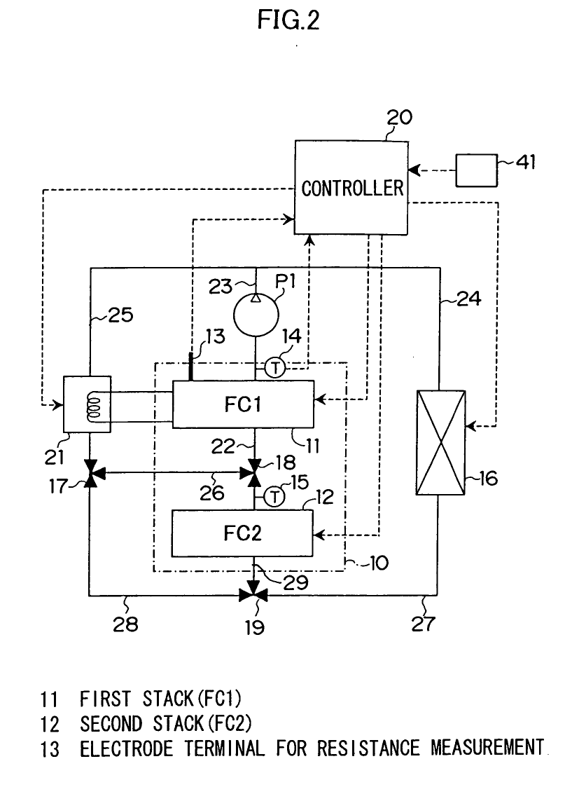

As shown in FIG. 2, the fuel cell 10 is composed of a first stack (FC1) 11 and a second stack (FC2) 12. The FC1 communicates with the FC2 by a pipe 22 provided with a temperature sensor 15 for measuring the temperature of circulating water ejected from a three-way valve 18 and the FC2.

Further, the first stack 11 is connected to one end of a pipe 23 provided with a water pump P1. The other end of the pipe 23 communicates with an electric thermal heater 21 through a pipe 25, and communicates with a radiator 16 through a pipe 24. A temperature sensor 14 for measuring the temperature of circulating water ejected from the FC1 is provided near a connection portion of the pipe 23 and the first stack 11. An electrode terminal 13 for measuring electric resistance value in a polymer electrolyte membrane (not shown) is attached to a wall surface of the first stack 11. Further, the second stack 12 is connected to one end of a pipe 29. The other end of the pipe 29 respectively communicates with the electric thermal heater 21 and the radiator 16 by pipes 27, 28 connected through a three-way valve 19. The pipe 28 communicates with the pipe 22 via a pipe 26 connected with three-way valves 17, 18 arranged at a middle portion of the pipes 28, 22. Thus, the circulating system, which circulates circulating water for controlling the temperature of the fuel cell 10, is constructed.

The first stack 11, the second stack 12, a water pump P1, the radiator 16, the electric thermal heater 21, the three-way valves 17 to 19, an outer air temperature measuring sensor 41, the electrode terminal 13 and temperature sensors 14, 15 are electrically connected to the controller 20, and operation timing thereof is controlled by the controller 20. The outer air temperature-measuring sensor 41 is provided such that the outer air temperature can be measured. The control unit 20 controls the usual power generating operation of the fuel cell for controlling the output by adjusting the amount of hydrogen gas and air depending on the load connected to the fuel cell 10. Also, the control unit 20 functions as a power stop controlling means for stopping power generation when power-generating operation is stopped. The power generation stoppage control will be described below.

In the first stack 11 and the second stack 12 of which the fuel cell 10 is composed, a plurality of single cells are laminated to make stack structure. Each single cell is composed of an electrode assembly having an anode diffusion electrode, a cathode diffusion electrode and a polymer electrolyte membrane such as a fluorine ion exchange resin film, held between the anode diffusion electrode and the cathode diffusion electrode, and a pair of separators which holds the electrode assembly, and forms a hydrogen gas flow passage in which hydrogen gas pass between the anode diffusion electrode and the separator and an air flow passage in which air passes between the cathode diffusion electrode and the separator. The fuel cell 10 supplies power to the outside portion by electrochemical reaction (cell reaction) by supplying hydrogen gas having high hydrogen density to a hydrogen gas flow passage and supplying air including oxygen to an air flow passage. The fuel cell 10 is a polymer electrolyte fuel cell.

The polymer electrolyte membrane can be composed of an electrolyte having ion conductivity, and perfluorosulfonic acid film or the like can be generally used. In the present embodiment, the polymer electrolyte membrane is composed of a Nafion® film (manufactured by Du Pont Co., Ltd.). The polymer electrolyte membrane is usually in a wet state from the viewpoint of improving ion conductivity. Hydrogen ion of the anode side obtained by supplying hydrogen gas is conducted well, and can be moved to the cathode side. The wet state can be formed by adding water (humidity) to hydrogen gas as fuel. Alternatively, water can be added to air including oxygen of the cathode side (humidity).

An anode diffusion electrode and a cathode diffusion electrode are composed of a catalyst layer for serving an electrochemical reaction and a diffusion layer that functions as a collector. The anode diffusion electrode is composed by laminating an anode catalyst layer and the diffusion layer in order from the polymer electrolyte membrane side, and the cathode diffusion electrode is composed by laminating a cathode catalyst layer and the diffusion layer in turn from the polymer electrolyte membrane side.

The anode catalyst layer and the cathode catalyst layer is composed by coating platinum, or an alloy containing platinum and other metals as a catalyst on the surface of the polymer electrolyte membrane. Carbon powder on which platinum or alloy containing platinum and other metals are supported is manufactured, and the carbon powder is dispersed in a suitable organic solvent. Appropriate amounts of an electrolyte solution (for instance, Nafion® Solution manufactured by Aldrich Chemical Corporation) is added to the organic solvent, and is made into a paste. The coating can be performed by screen-printing or the like on the polymer electrolyte membrane. The paste containing the carbon powder is molded in the film to make to a sheet, and the sheet can be pressed on the polymer electrolyte membrane. Platinum or an alloy containing platinum and other metals may be coated not on the polymer electrolyte membrane but on the surface of the diffusion layer of the side opposite to the polymer electrolyte membrane.

Each diffusion layer is formed by carbon cloth woven by string containing carbon fiber. The diffusion layer is preferably composed of carbon paper and carbon felt or the like containing carbon fiber besides the carbon cloth.

The separator is provided such that the electrode assembly is further interposed between the anode diffusion membrane and the cathode diffusion membrane. A hydrogen gas flow passage is formed between the anode diffusion electrode composing the electrode assembly and the separator, and an airflow passage is formed between the cathode diffusion electrode and the separator. The separator can be composed of a gas impermeable electroconductive member, for instance, densified carbon, which is made gas impermeable by compressing carbon. In the separator, when a plurality of single cells are laminated to make a stack structure, one separator is shared between two the electrode assemblies and the flow passage is formed on both surfaces of the separator.

One end of a hydrogen supply pipe 3 1, which is provided with a shut valve V1, a high-pressure regulator V2, a low-pressure regulator V3 and a shut valve V4 is connected to the anode side of the fuel cell 10 so as to communicate with supply openings of hydrogen gas flow passages of the first stack 11 and the second stack 12, and to communicate with a hydrogen tank 30. One end of a pipe (not shown), in which a connector for filling is attached to the other end thereof is connected to the wall surface of the hydrogen tank 30, and thereby the hydrogen gas can be filled at high-pressure. At this time, the pressure and supply amount of hydrogen gas supplied to the hydrogen gas flow passage of each stack can be easily adjusted by controlling the opening/shutting state of the shut valve V1, the high-pressure regulator V2, the low-pressure regulator V3 and the shut valve V4. The shut valve V4 is especially used when it is necessary to confine hydrogen (for instance, in an emergency or the like). In place of the hydrogen tank 20, it is possible to generate hydrogen by a reforming reaction in which alcohol, hydrocarbon and aldehyde or the like are raw materials and to supply hydrogen to the anode side.

One end of a pipe 32 provided with a valve V7 for ejecting exhaust gas (anode off gas) and a hydrogen pump P2 for pressurizing the anode off gas is further connected to the anode side. The valve V7 is especially used when it is necessary to confine hydrogen (for instance, in an emergency or the like). The pipe 32 is branched into two in the middle. One end of the pipe 32 is connected to an exhaust pipe 33 for ejecting anode off gas outside, and the other end of the pipe 32 is connected to a hydrogen supply pipe 31 through a check valve V6.

A valve V5 is provided in the exhaust pipe 33, and the other end thereof is connected to a dilution machine 35. The anode off gas is circulation-supplied to the fuel cell 10 again through the hydrogen supply pipe 31 while the valve V5 provided in the exhaust pipe 33 is shut. Since the hydrogen, which is not consumed by the power generating operation remains in the anode off gas, the hydrogen can be effectively used by circulating. On the other hand, impurities other than hydrogen, for instance, nitrogen or the like, which have penetrated the polymer electrolyte membrane from the cathode, remain without being consumed while the anode off gas is circulated, and thereby impurity density increases gradually. Under such a condition, the anode off gas is diluted with air by the dilution machine 35 through the exhaust pipe 33 by opening the valve V5, is ejected outside, and thereby the amount of circulation of impurity is reduced. In this case, since the hydrogen is ejected at the same time in this case, suppression of the opening of the valve V5 can be selected as much as possible from the viewpoint of economizing of fuel cost.

One end of an air supply pipe 37 provided with a compressor 38 and a humidifier 39 is connected to the cathode side of the fuel cell 10 so as to be communicated with each air passage supply inlet of the first stack 11 and the second stack 12. One end of the exhaust pipe 34 provided with a pressure-adjusting valve V8 communicates with each air passage exhaust inlet. The exhaust air (cathode off gas) in which the oxygen density is lowered by the supply of air to the air passage of fuel cell 10 and the cell reaction, and the generation water can be exjected. The opening of the pressure-adjusting valve V8 controls the supply pressure of air. A filter 40 is attached to the other end of the air supply pipe 37, and the other end of the exhaust pipe 34 is connected to a muffler 36.

In the power generating operation of the fuel cell 10, the hydrogen gas is supplied to the hydrogen gas flow passage in specified hydrogen pressure through the hydrogen supply pipe 31 from the hydrogen tank 30 at the anode side of the first stack 11 and the second stack 12. Also, the air (oxygen) sucked through the filter 40 at the cathode side, is compressed with the compressor 38 and further humidified with the humidifier 39, is supplied to the air passage at the specified supply pressure through the air supply pipe 37. Since the increase in pressure of the hydrogen gas and air supplied in general causes the rise of reaction velocity in the fuel cell, and the power generation efficiency is improved, the hydrogen gas and the air are pressurized as described previously. The anode off gas is ejected outside through the pipe 32 and the exhaust pipe 33, and the cathode off gas (may include moisture) is exhausted from the other end of the exhaust pipe 34 through the muffler 36.

Next, the control routine by the control unit 20 of the fuel cell system in the embodiment, especially, the power generation stoppage control routine performed when power generating operation of the fuel cell is stopped and the power generation starting control routine for restarting after performing the power generation stoppage control and stopping, will be described with reference to FIG. 2 to FIG. 7.

When the power generating operation is stopped after a usual power generating operation is performed by supplying hydrogen gas and air to the fuel cell 10 as discussed above, the power generation stoppage control which stops the power generating operation is performed after generating power for setting the temperature of the fuel cell 10 to a specified value or higher (for instance, 70° C.) at the time of stopping the power generating operation by the first stack 11 and the second stack 12 of the fuel cell to avoid the internal freezing of the fuel cell in the low temperature region which is 0° C. or lower. In the present embodiment, the temperature of the fuel cell in the power generation stoppage control is based on the temperature (T_{FC1}) of the first stack 11. The temperature T_{FC1} can be detected by the temperature sensor 14 provided near a connection portion of the pipe 23 connected to the first stack.

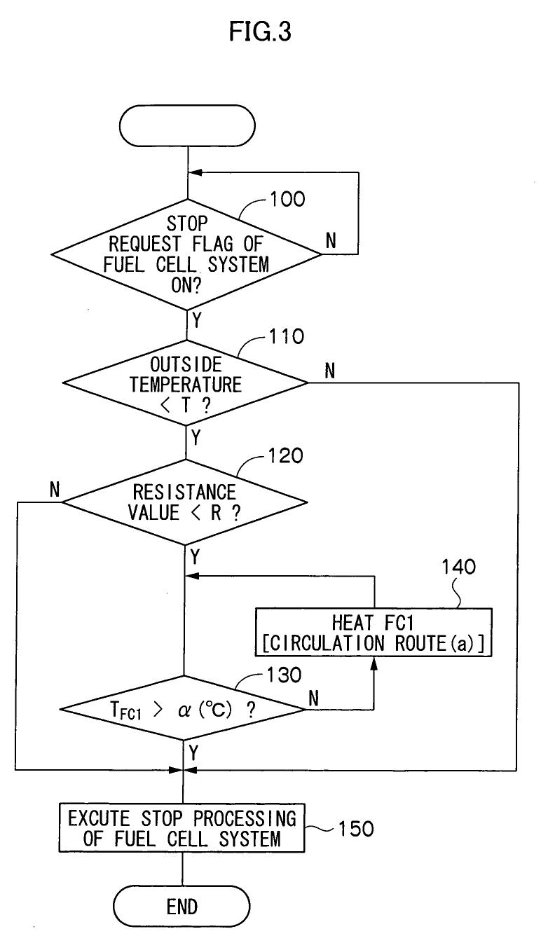

FIG. 3 is a flow chart showing a power generation stoppage control routine. It is determined whether a stop request flag of the fuel cell 10 is ON or not in a step 100 when the routine is performed. When determining that the flag is ON, on the stop request of the fuel cell system, since S_{SW} is turned off in interlocking with a start switch S_{SW} or is compelled to stop by the occurrence of trouble or the like, the system is moved to next step 110. When determining that the flag is not ON, until the stop request flag is ON, that is, the system is controlled by a usual power generating operation of the fuel cell until the stoppage of the fuel cell system is requested.

It is determined whether the outside temperature is a specified value T or lower (for instance, 0° C.) in the step 110. When determining that the outside temperature is a specified value T or lower, since the fuel cell may freeze after stopping, it is determined whether internal portion of the first stack is in a dry state or not, that is, whether the resistance value is a specified value R or greater or not based on the resistance value obtained from the electrode terminal 13 attached to the first stack 11 in the next step 120. Since the danger of moisture remaining internally freezing does not exist when determining that the outside temperature exceeds a specified value T, both (fuel cell 10) the first stack 11 and the second stack 12 are stopped as in the step 150, and the fuel cell system is stopped.

In the step 120, it is determined that the inside of the first stack has already been in a dry state when determining that the resistance value is a specified value R or greater. Because it is possible to start even if the fuel system is cooled below the freezing point after stopping, both (fuel cell 10) the first and the second stack are stopped in the step 150 and the fuel cell system is stopped. It is determined that the inside of the first stack 11 is not a dry state when determining that resistance value is the specified value R or lower. It is determined whether the temperature (T_{FC1}) of the first stack (FC1) 11 reached the temperature α (for instance, 70° C.) for obtaining a dry state enough or not in the next step 130, that is, whether or not T_{FC1}>α is satisfied or not (whether it is possible to start even when reaching 0° C. or lower after stopping or not).

Herein, when the dry state can be determined by watching the resistance value, it is not necessary to determine whether or not T_{FC1}>α is satisfied in the step 130.

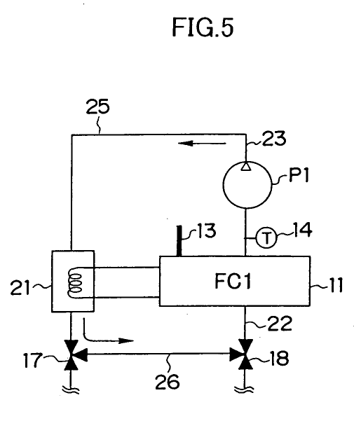

In the step 130, when it is determined that T_{FC1}>α is satisfied, both the first and the second stack are stopped in the step 150, and the fuel cell system is stopped. When it is determined that T_{FC1}>α is not satisfied, the opening/shutting states of three-way valves 17 and 18 are switched in step 140. Circulation water is circulated in an arrow direction by using a circulation system shown in FIG. 2 as a circulation route (a) shown in FIG. 5. The hydrogen gas and air are supplied to only the first stack 11 and electricity is generated further. The electrothermal heater 21 is turned on by the electric power generated, and the circulation water in a high load state is heated. The first stack 11 is continuously heated by the heat of the circulation water and the heat in the cell reaction at the time of generating electricity until the temperature T_{FC1} of the first stack 11 exceeds the temperature α (T_{FC1}>α is satisfied). When T_{FC1}>α is satisfied, both the first stack 11 and the second stack 12 (fuel cell 10) are stopped in the step 150 in the same manner as the above procedure, and the fuel cell system is stopped.

The above power generation stoppage control can be properly performed by turning on a auxiliary switch provided in a vehicle after the fuel cell system is stopped once. In this case, when the auxiliary switch is turned on, it is determined whether the outside temperature is a specified value T (for instance, 0° C.) or lower or not in the step 110. When it is determined that the outside temperature is the specified value T or lower, since the fuel cell may freeze after stopping, the same process as described above is performed in the next step 120 after measuring the resistance value for determining whether the inside of the first stack is in a dry state or not. When T_{FC1}>α is satisfied, the fuel cell system is stopped again. In this case, it is not necessary to judge in the step 130 when not required.

The power generation stoppage control can be set to be basically always performed, and can be set to be tuned as appropriate by using the auxiliary switch or the like. As a result, the process is performed even when the power generation stoppage control is not necessary such as summer or the like, and wasting the hydrogen gas can be avoided.

In the above example, the power generation stoppage control can be performed when the outside temperature is the specified value T or lower and the inside of the stack is not in a dry state. The power generation stoppage control may be performed when the outside temperature is the specified value T or lower, or the inside of the stack is not in a dry state.

Even when the first stack and the second stack are cooled below the freezing point while stopping, the frozen moisture of the first stack is at least avoided by performing the power generation stoppage control for stopping the power generating operation after generating power as described above, and thereby the entire fuel cell system can be reactivated. That is, the fuel cell 10 can be started within a short period of time as described above.

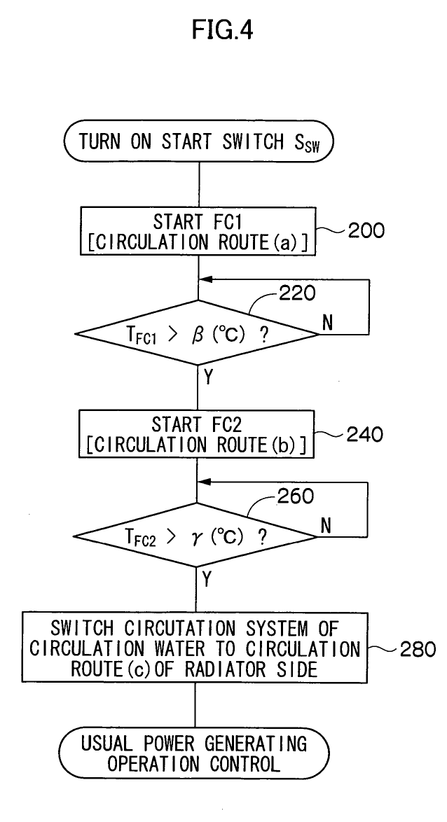

When the fuel cell system is stopped by performing the power generation stoppage control in the first stack 11 as described above, the power generating start control routine is performed by turning on a start switch S_{SW} shown in FIG. 4. The whole fuel cell 10 is restarted by starting the first stack 11 performed the power generation stoppage control firstly and performing the power generating operation.

When the start switch S_{SW} is turned on, only the first stack (FC1) 11 is started in the step 200, and the circulation water is circulated by switching the opening/shutting states of three-way valves 17, 18 in the arrow direction making the circulation system shown in FIG. 2 as circulation route (a) shown in FIG. 5. At this time, the circulation water is heated by the heat due to the cell reaction of the first stack 11, and the electric power generated in the first stack 11 is converted into heat by using an electrothermal heater 21 and it is warmed. As a result, the time required for heating the first stack 11 of the fuel cell can be shortened.

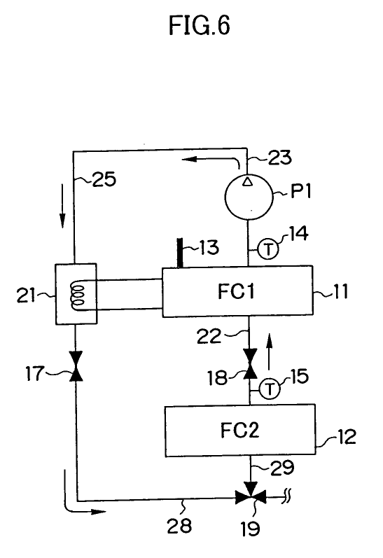

After heating the heat of the first stack 11 in the step 200, it is determined whether the temperature T_{FC1} of the first stack 11 reaches the temperature β (for instance, 0° C.) which is stable and which can be output or not in the next step 220, that is, determining whether T_{FC1}>β is satisfied or not. When determining that T_{FC1}>β is satisfied, the circulation water is circulated in the arrow direction making the circulation system shown in FIG. 2 as circulation route (b) shown in FIG. 6 by switching the opening/shutting state of three-way valves 17, 18, 19 in the step 240, the second stack (FC2) 12 is heated, and the second stack 12 is started. Though the time required for returning to the condition in which the power generation is possible varies depending on the amount of moisture remaining in the second stack 12 when stopping. However, the electricity can be generated by circulating the circulation water while performing the power generation of the first stack as described above when exceeding at least 0° C. After the power generating operation of the second stack is possible, the second stack is heated to the operating temperature, which is the best power generation efficiency, by the power generating operation of both the first and the second stack.

After the power generating operation of the second stack (FC2) 12 is started as described above, it is determined whether the temperature T_{FC2} exceeds a permissible operating temperature γ (for instance, 80° C.) or not, that is, whether T_{FC2}>γ is satisfied or not by an excessive increase of the temperature (T_{FC2}) of the second stack 12 in the step 260. The temperature T_{FC2} can be detected by the temperature sensor 15 provided near a connection portion of the pipe 22 connected to the second stack.

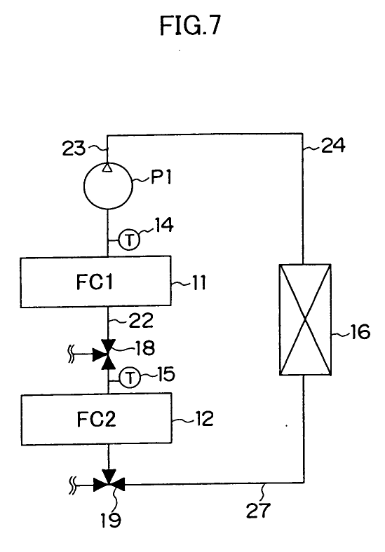

When determining that T_{FC2}>γ is satisfied in the step 260, the circulation water is cooled and circulated through the radiator 16 by switching the opening/shutting state of three-way valves 17, 18, 19 and by making the circulation system shown in FIG. 2 as circulation route (c) shown in FIG. 7 in the next step 280. The fuel cell shifts to the usual power generating operation control, which generates power while cooling the first stack (FC1) 11 and the second stack (FC2) 12. Therefore, the output being decreased by drying resulting from the excessive temperature rise in the first stack 11 and the second stack 12 can be prevented. When determining that T_{FC2}>γ is not satisfied in the step 280, the power generating operation of the first stack 11 and the second stack 12 is continued while circulating the circulation water in the state of the circulation route (b). When determining that T_{FC2}>γ is satisfied in the step 260, the fuel cell is controlled by the usual power generating operation which operates the power generation while cooling in the same way as described above, in the step 280.

Thus, even when the fuel cell is maintained in the low temperature region which is 0° C. or lower while stopping, the internal freezing of at least one portion of the stack portion of which the fuel cell is composed can be effectively eliminated, and the startability at the time of reactivating can be effectively improved. As a result, the power supply to the load can be stably performed under the low temperature environment, which is 0° C. or lower, and it is possible to reactivate promptly after stopping.

In the above embodiment, the polymer electrolyte fuel cell (PEFC) which uses hydrogen gas as fuel is described. In addition, a direct methanol fuel cell (DMFC) which uses a methanol solution can be used in place of the polymer electrolyte fuel cell.

The example of mounting the fuel cell system on the electric vehicle is described above. Further, it is possible to apply as a power supply source to other moving device other than the electric vehicle and the device operated by electric energy other than the moving device.

According to the invention, a fuel cell system solving the internal freezing of moisture under low temperature environment, and excelling in the low temperature startability can be provided.

What is claimed is:

1. A fuel cell system comprising:
power generation stoppage control means for performing power generation stoppage control for stopping power generating operation after generating power for making the temperature of a specified portion of a fuel cell be a specified value or greater when the power generating operation of the fuel cell is stopped.

2. The fuel cell system of claim 1, wherein the power generation stoppage control means performs power generation stoppage control for stopping the power generating operation after generating power in a specified high load state when the power generating operation of the fuel cell is stopped.

3. The fuel cell system of claim 1, wherein the fuel cell comprises a stack portion including a plurality of stack structural units, and the power generation stoppage control is performed in at least one portion of the plurality of stack structural units.

4. The fuel cell system of claim 3, wherein the power generating operation is performed by the stack structural unit in which the power generation stoppage control has been performed when starting.

5. The fuel cell system of claim 1, wherein the power generation stoppage control is performed when an outside temperature is a specified value or lower.

6. The fuel cell system of claim 1, further comprising means for determining whether an internal portion of the stack portion is in a dry state or not, wherein the power generation stoppage control is performed when by the dryness determining means for determining determines that the internal portion of the stack portion is not in the dry state.

7. The fuel cell system of claim 1, wherein the fuel cell is a polymer electrolyte fuel cell.

8. A method of controlling a fuel cell comprising:
performing power generation stoppage control for stopping power generating operation after generating power to make a temperature of a specified portion of the fuel cell be a specified value or greater when the power generating operation of the fuel cell is stopped.

9. The method of claim 8, wherein the power generation stoppage controlling includes stopping the power generating operation after generating power in a specified high load state.

10. The method of claim 8, wherein the fuel cell comprises a stack portion including a plurality of stack structural units, and the power generation stoppage control is performed in at least one portion of the plurality of stack structural units.

11. The method of claim 10, wherein the power generating operation is performed by the stack structural unit in which the power generation stoppage control has been performed when starting.

12. The method of claim 8, wherein the power generation stoppage control is performed when an outside temperature is a specified value or lower.

13. The method of claim 8, further comprising determining whether an internal portion of the stack portion is in a dry state or not, wherein the power generation stoppage control is performed when the dryness determining means determines that the internal portion of the stack portion is not in the dry state.
determining means determines that the internal portion of the stack portion is not in the dry state.
